(19) United States
(12) Patent Application Publication
(10) Pub. No.: US 2022/0349039 A1
(43) Pub. Date: Nov. 3, 2022

(54) WELDED STRUCTURAL MEMBER HAVING EXCELLENT STRESS CORROSION CRACKING RESISTANCE, AND METHOD FOR MANUFACTURING SAME

(71) Applicant: UACJ CORPORATION, Tokyo (JP)

(72) Inventors: Shuhei SHAKUDO, Tokyo (JP); Ken ATSUTA, Tokyo (JP)

(21) Appl. No.: 17/754,405

(22) PCT Filed: Oct. 8, 2020
(86) PCT No.: PCT/JP2020/038115

§ 371 Date: Mar. 31, 2022

(30) Foreign Application Priority Data
Oct. 9, 2019 (JP) 2019-186120

(51) Int. Cl. C22F 1/053; C22C 21/10; B23K 31/00; B23K 9/23

(52) U.S. Cl. CPC C22F 1/053; C22C 21/10; B23K 31/00; B23K 9/23; B23K 2103/10

(57) ABSTRACT

Provided is a welded structural member with excellent stress corrosion cracking resistance, which includes: a 7000-series aluminum alloy material that has a chemical composition containing 6.6% by mass to 8.5% by mass of Zn, 1.0% by mass to 2.1% by mass of Mg, 0.10% by mass to 0.20% by mass of Zr, and 0.001% by mass to 0.05% by mass of Ti, with a remainder including Al and unavoidable impurities, and includes a metallographic structure that is a fibrous structure; and other aluminum alloy material welded with the 7000-series aluminum alloy material. In this welded structural member, when an electrical conductivity of the 7000-series aluminum alloy material before an artificial aging treatment is defined as X % IACS and the electrical conductivity of the 7000-series aluminum alloy material after the artificial aging treatment is defined as Y % IACS, the following equation is satisfied: 0.120≤(Y/X−1)≤0.250 is satisfied, and a difference in the electrical conductivity of the 7000-series aluminum alloy material between a mother portion other than a weld heat-affected zone and the weld heat-affected zone is 5% IACS or less.

### TECHNICAL FIELD

The present disclosure relates to a welded structural member with excellent stress corrosion cracking resistance and a method of producing the same.

### BACKGROUND ART

High-strength and lightweight 7000-series aluminum alloy materials have been increasingly employed as a material of a member in which a weight reduction is demanded, such as a transportation equipment.

Although 7000-series aluminum alloy materials have excellent mechanical properties, they have a concern for the occurrence of stress corrosion cracking. In addition, when a 7000-series aluminum alloy material is joined by arc welding or the like, not only the strength is reduced due to the thermal effect of the arc welding or the like but also the corrosion resistance and the stress corrosion cracking resistance are impaired in the vicinity of the welded part.

As a method of improving the stress corrosion cracking resistance of a 7000-series aluminum alloy material, Patent Literature 1 discloses a method in which a material is subjected to an aging treatment so as to obtain a highest strength, and subsequently brought into an overaged state by performing a reheating treatment in the coating-baking step.

Further, Patent Literature 2 proposes a method of producing a 7000-series aluminum alloy extruded material, which method is characterized by performing a two-step artificial aging treatment.

Moreover, Patent Literature 3 proposes to improve the stress corrosion cracking resistance by subjecting a welding material to a solution heat treatment and then an artificial aging treatment.

### CITATION LIST

### Patent Literatures

Patent Literature 1: Unexamined Japanese Patent Application Publication No. 2006-233336
Patent Literature 2: Unexamined Japanese Patent Application Publication No. 2010-275611
Patent Literature 3: Unexamined Japanese Patent Application Publication No. 2000-317676

### SUMMARY OF INVENTION

### Technical Problem

In Patent Literature 1, an aging treatment is performed under the conditions of “at 117 to 123° C. for 18 to 24 hours, or at 127 to 133° C. for 11 to 14 hours” to obtain a highest strength, and an overaging treatment is performed thereafter. However, these conditions require a long treatment time. In addition, when the matrix is excessively aged, sufficient mechanical properties may not be obtained upon welding. Further, at a low treatment temperature of lower than 145° C., η′ phase (MgZn₂) continuously precipitates at grain boundaries; however, this is a factor that causes a reduction in the stress corrosion cracking resistance.

In Patent Literature 2, the conditions of two-step aging are prescribed as follows: “the heat treatment temperature of the first step is in a range of 70 to 100° C., and the heat treatment temperature of the second step is in a range of 140 to 170° C.”. Further, in Patent Literature 2, it is stated as follows: “in the two-step aging treatment under the production conditions, the heat treatment temperature of the second step was set at 140° C. to 170° C., and the treatment time was set at 20 hours or shorter”. However, the retention time of the heat treatment temperature in the second step is unclear. For instance, even if the heat treatment temperature condition of the second step is 140° C. to 170° C., a short retention time leads to underaging; therefore, a sufficient stress corrosion cracking resistance cannot be obtained. In addition, even if the heat treatment temperature condition of the second step is 140° C. to 170° C., a sufficient strength cannot be obtained when the retention time is long.

In Patent Literature 3, a solution heat treatment and quenching are performed on the welding material after welding. This heat treatment method has a problem of requiring a high cost.

The present disclosure was made in view of the above-described circumstances, and an objective of the present disclosure is to provide: a welded structural member with excellent stress corrosion cracking resistance, in which not only the corrosion resistance and the stress corrosion cracking resistance of a 7000-series aluminum alloy material in its mother portion and the vicinity of a welded part are improved but also the strength of the welded part is increased; and a method of producing the same.

### Solution to Problem

In order to achieve the above-described objective, the welded structural member according to a first aspect of the present disclosure is characterized by including:

a 7000-series aluminum alloy material that has a chemical composition containing 6.6% by mass to 8.5% by mass of Zn, 1.0% by mass to 2.1% by mass of Mg, 0.10% by mass to 0.20% by mass of Zr, and 0.001% by mass to 0.05% by mass of Ti, with a remainder including Al and unavoidable impurities, and includes a metallographic structure that is a fibrous structure; and

other aluminum alloy material welded with the 7000-series aluminum alloy material,

wherein

when an electrical conductivity of the 7000-series aluminum alloy material before an artificial aging treatment is defined as X % IACS and the electrical conductivity of the 7000-series aluminum alloy material after the artificial aging treatment is defined as Y % IACS, the following equation is satisfied:

0.120≤(Y/X−1)≤0.250, and

a difference in the electrical conductivity of the 7000-series aluminum alloy material between a mother portion other than a weld heat-affected zone and the weld heat-affected zone is 5% IACS or less.

The 7000-series aluminum alloy material may further contain 0.50% by mass or less of Cu.

The 7000-series aluminum alloy material may further contain one or both of 0.40% by mass or less of Mn and 0.20% by mass or less of Cr.

The 7000-series aluminum alloy material may contain 6.6% by mass to 7.6% by mass of Zn, and 1.0% by mass to 1.6% by mass of Mg.

In order to achieve the above-described objective, The production method according to a second aspect of the present disclosure is characterized by including:

the first artificial aging treatment step of maintaining a 7000-series aluminum alloy material at a temperature of 90 to 110° C. for 1 to 5 hours, which 7000-series aluminum alloy material has a chemical composition containing 6.6% by mass to 8.5% by mass of Zn, 1.0% by mass to 2.1% by mass of Mg, 0.10% by mass to 0.20% by mass of Zr, and 0.001% by mass to 0.05% by mass of Ti, with a remainder including Al and unavoidable impurities, and includes a metallographic structure that is a fibrous structure;

the second artificial aging treatment step of maintaining the 7000-series aluminum alloy material subjected to the first artificial aging treatment step at a temperature of 145 to 160° C. for 4 to 12 hours;

the welding step of welding the 7000-series aluminum alloy material subjected to the second artificial aging treatment step with other aluminum alloy material to form a welded structure; and

the heat treatment step of heat-treating the welded structure at a temperature of 165 to 195° C. for 10 to 60 minutes.

The 7000-series aluminum alloy material may further contain 0.50% by mass or less of Cu.

The 7000-series aluminum alloy material may further contain one or both of 0.40% by mass or less of Mn and 0.20% by mass or less of Cr.

The 7000-series aluminum alloy material may contain 6.6% by mass to 7.6% by mass of Zn, and 1.0% by mass to 1.6% by mass of Mg.

### Advantageous Effects of Invention

The welded structural member according to the present disclosure is produced by artificially aging a 7000-series aluminum alloy material in two steps to improve the stress corrosion cracking resistance, and subsequently heat-treating a welded structure, in which the aluminum alloy material is welded, at 165 to 195° C. By this, a difference in the electrical conductivity of the 7000-series aluminum alloy material between a mother portion and a weld heat-affected zone is controlled to be 5% IACS or less. Therefore, an increase in the strength as well as an improvement in the corrosion resistance and the stress corrosion cracking resistance can be easily achieved.

### BRIEF DESCRIPTION OF DRAWINGS

FIG. 1 is a drawing that illustrates a mode of build-up welding and positions of electrical conductivity measurement in Examples;

FIG. 2 is a drawing that illustrates a metallographic structure observation method employed in Examples; and

FIG. 3 is a drawing that illustrates a mode of stress loading in the SCC test conducted in Examples.

### DESCRIPTION OF EMBODIMENTS

The 7000-series aluminum alloy material used in the present embodiment desirably has a composition containing 6.6% by mass to 8.5% by mass of Zn, 1.0% by mass to 2.1% by mass of Mg, 0.10% by mass to 0.20% by mass of Zr, and 0.001% by mass to 0.05% by mass of Ti, with a remainder including Al and unavoidable impurities.

First, with regard to the 7000-series aluminum alloy material, the prescribed ranges of chemical composition values will be described.

A 7000-series aluminum alloy is a precipitation strengthened alloy. In the 7000-series aluminum alloy material, Zn and Mg coexist in aluminum to cause η′ phase to precipitate, and this contributes to improvement of mechanical properties. The 7000-series aluminum alloy material contains 6.6% by mass to 8.5% by mass of Zn, and 1.0% by mass to 2.1% by mass of Mg.

Zn: 6.6% by mass to 8.5% by mass

When the Zn content is less than 6.6% by mass, sufficient mechanical properties cannot be obtained since the amount of the η′ phase co-precipitating with Mg is reduced. On the other hand, when the Zn content is higher than 8.5% by mass, the stress corrosion cracking resistance is reduced. Therefore, the Zn content is set to be 6.6% by mass to 8.5% by mass. A more preferred range is 6.6% by mass to 7.6% by mass.

Mg: 1.0% by mass to 2.1% by mass

When the Mg content is less than 1.0% by mass, sufficient mechanical properties cannot be obtained since the amount of the phase co-precipitating with Zn is reduced. On the other hand, when the Mg content is higher than 2.1% by mass, the hot workability is deteriorated and the productivity is thus reduced. Therefore, the Mg content is set to be 1.0% by mass to 2.1% by mass. A more preferred range is 1.0% by mass to 1.6% by mass.

The above-described aluminum alloy material further contains, in addition to the above-described elements, 0.10% by mass to 0.20% by mass of Zr and 0.001% by mass to 0.05% by mass of Ti as trace additive elements.

Zr: 0.10% by mass to 0.20% by mass

By incorporating Zr, the stress corrosion cracking resistance is improved. In addition, an Al—Zr intermetallic compound is formed and the generation of a recrystallized structure is thereby inhibited, so that a cross-section is given a fibrous structure and the stress corrosion cracking resistance is improved. When the Zr content is less than 0.10% by mass, a fibrous structure cannot be obtained. On the other hand, when Zr is incorporated in an amount of greater than 0.20% by mass, a coarse Al—Zr intermetallic compound is formed, and the formability is deteriorated. A more preferred range of the Zr content is 0.10% by mass to 0.15% by mass.

Ti: 0.001% by mass to 0.05% by mass

Ti, when incorporated into an ingot, has an effect of refining the ingot structure. By refining the ingot structure, cracking of the ingot is inhibited and a fine structure is eventually obtained, which are advantageous in terms of the stress corrosion cracking resistance. When the Ti content is less than 0.001% by mass, the effects of the refinement are not sufficiently obtained. Meanwhile, when Ti is incorporated in an amount of greater than 0.05% by mass, point defects are likely to be generated due to, for example, coarsening of an Al—Ti intermetallic compound. It is noted here that Ti, when incorporated into an ingot along with B as a TiB compound or the like, refines the ingot structure in the same manner as in the case of being incorporated by itself. When Ti is incorporated as a TiB compound, less than 0.003% by mass B is contained therein.

In addition to the above-described composition, 0.50% by mass or less of Cu may be incorporated as well.

Cu: 0.50% by mass or less

By incorporating Cu, an electric potential difference between crystal grain boundaries and inside of crystal grains is reduced, so that sacrificial dissolution at the crystal grain boundaries is inhibited. As a result, the stress corrosion cracking resistance is improved. Meanwhile, a Cu content of more than 0.50% by mass presents a concern for a reduction of general corrosion resistance.

In addition to the above-described composition, one or both of 0.40% by mass or less of Mn and 0.20% by mass or less of Cr may be incorporated as well.

Mn: 0.40% by mass or less, Cr: 0.20% by mass or less

In the same manner as Zr, incorporation of Cr and/or Mn inhibits the generation of a recrystallized structure and gives a fibrous structure to a cross-section, and the stress corrosion cracking resistance is thereby improved. Meanwhile, when Cr or Mn is added in an amount greater than the respective prescribed amount, the hot workability is deteriorated. Particularly, when Cr is added in an amount greater than the prescribed amount, the quench sensitivity is increased.

The above-described aluminum alloy material includes a metallographic structure that is a fibrous structure. The term “fibrous structure” used herein refers to a metallographic structure constituted by crystal grains having a high aspect ratio in one specific direction. For example, in the observation of a cross-section from a plane that is parallel to a processing direction (for example, the extrusion direction in the case of an extruded material) and perpendicular to the width direction of the material, the metallographic structure can be deemed to be a fibrous structure when the aspect ratio of the crystal grain size in the processing direction with respect to the crystal grain size in the thickness direction is 5 or higher. By controlling the metallographic structure to be fibrous, not only a strength-improving effect can be obtained but also the stress corrosion cracking resistance can be improved. The metallogaphic structure can be verified by, for example, observing a cross-section of the aluminum alloy material under a polarization microscope.

In the aluminum alloy material, the ratio of the area occupied by the fibrous structure is preferably 70% or higher at a cross-section that is parallel to the processing direction of the aluminum alloy material and perpendicular to the width direction of the material.

The aluminum alloy material has a yield strength, which is defined in JIS Z2241 (ISO6892-1), of preferably 350 MPa or higher, more preferably 380 MPa or higher. By this, the strength characteristics required for achieving a reduction in the thickness and the weight of a member can be obtained.

Next, a method of producing a welded structural member will be described.

The welded structural member of the present disclosure can be divided into a 7000-series aluminum alloy material and other aluminum alloy material welded with the 7000-series aluminum alloy material (hereinafter, the other aluminum alloy material is also referred to as “welding member”). As the 7000-series aluminum alloy material, for example, a hot-rolled material or a hot-extruded material can be used. The welding member is not particularly limited as long as it is an aluminum alloy material. In the present embodiment, particularly a case where the 7000-series aluminum alloy material is made into an extruded profile will be described.

A 7000-series aluminum alloy extruded material is produced by preparing an ingot from a melt of the chemical composition of the present disclosure and subjecting this ingot to a homogenization treatment, a hot extrusion treatment, a solution heat treatment, and an artificial aging treatment. This 7000-series aluminum alloy extruded material is joined with a welding member by welding. The 7000-series aluminum alloy extruded material and the welding member that are welded together are used as a welded structure, and this welded structure is heat-treated, whereby a welded structural member of the present disclosure is obtained.

Homogenization Treatment Step

First, a homogenization treatment is performed in which an ingot having the above-described chemical composition values is maintained at a temperature of 450 to 500° C. for 5 to 12 hours.

The ingot is not sufficiently homogenized at a temperature of lower than 450° C. Meanwhile, at a temperature of higher than 500° C., the crystal structure of an Al—Zr intermetallic compound is deteriorated and coarsened. Due to this deterioration and coarsening of the crystal structure of the Al—Zr intermetallic compound, a fibrous metal structure cannot be obtained, and the effect of improving the stress corrosion cracking resistance is thus deteriorated. Further, sufficient homogenization is not attained when the retention time in the homogenization treatment is shorter than 5 hours. Meanwhile, since the ingot is in a sufficiently homogenized state once the retention time exceeds 12 hours, a longer retention time is not expected to have a further effect. Therefore, in the homogenization treatment, it is desirable to maintain the ingot at a temperature of 450 to 500° C. for 5 to 12 hours.

Hot Extrusion and Solution Heat Treatment Step

From the ingot subjected to the above-described homogenization treatment, an extruded profile is produced by hot extrusion. The temperature prior to the hot extrusion is controlled at 450 to 500° C. When this temperature is lower than 450° C., the deformation resistance is increased. Meanwhile, when the temperature is higher than 500° C., the crystal structure of the Al—Zr intermetallic compound formed during the homogenization treatment is changed and coarsened. As a result, a fibrous metal structure cannot be obtained, and the effect of improving the stress corrosion cracking resistance is thus deteriorated.

After the hot extrusion, the resulting extruded profile is cooled to a temperature of 150° C. or lower. In the hot extrusion, the temperature of the extruded profile after the extrusion reaches a solution heat treatment temperature. By controlling the average cooling rate to be 25° C./min to 1,000° C./sec during the subsequent cooling, the same effect as that of a solution heat treatment can be obtained. When the cooling rate is lower than 25° C./min, sufficient mechanical properties cannot be obtained due to a reduction in the solid solution amount of solute elements. When the cooling rate is higher than 1,000° C./sec, an excessively large equipment is required, and a commensurate effect cannot be obtained.

Further, the extruded profile once cooled to a temperature of 150° C. or lower may be heated again to a solution heat treatment temperature and then cooled at the above-described cooling rate.

Subsequently, after the above-described cooling is performed, the extruded profile is further cooled to room temperature. To achieve this, the extruded profile may be cooled to room temperature by the above-described cooling, or may be cooled by other method.

Artificial Aging Treatment Step

Next, an artificial aging treatment is performed on the extruded profile. This artificial aging treatment causes an η′ phase, which is a strengthening phase, to precipitate, and the mechanical properties of the extruded profile are thereby improved. Artificial aging is carried out by a first artificial aging treatment (first artificial aging treatment step) and a second artificial aging treatment (second artificial aging treatment step). In the first artificial aging treatment, the extruded profile is maintained at a temperature of 90 to 110° C. for 1 to 5 hours. Subsequently, continuously from the first artificial aging treatment, the second artificial aging treatment is performed in which the extruded profile is maintained at a temperature of 145 to 160° C. for 4 to 12 hours. In the first artificial aging treatment, GP(II) that will transition into an if phase is formed. Further, in second artificial aging treatment, the thus formed GP(II) transitions into an η′ phase.

Regarding the first artificial aging treatment, GP(II) is not formed densely when the first artificial aging temperature is lower than 90° C. or the aging time is shorter than 1 hour. This leads to insufficient formation of η′ phase in the second artificial aging, and a sufficient precipitation strengthening effect cannot be obtained. When the first artificial aging temperature is higher than 110° C., the formation of η′ phase starts without sufficient formation of GP(II) and, in this case as well, the precipitation of η′ phase can be insufficient. Meanwhile, when the first artificial aging time is 5 hours or longer, the effect obtained by the first artificial aging is saturated.

Regarding the second artificial aging treatment, the extruded profile is underaged when the second artificial aging temperature is lower than 145° C. or the aging time is shorter than 4 hour. In this case, the stress corrosion cracking resistance of the mother portion is reduced. In addition, when the aging temperature is lower than 145° C., although phase precipitates uniformly, the phase is in a continuous state at grain boundaries. By performing the artificial aging treatment at 145° C. or higher, the η′ phase at grain boundaries is aggregated and coarsened, as a result of which the η′ phase of 0.02 μm or larger in diameter is brought into a state of being scattered on the grain boundaries, and the stress corrosion cracking resistance is thereby improved. When the second artificial aging temperature is higher than 160° C. or the aging time is longer than 12 hours, sufficient mechanical properties cannot be obtained due to excessive aging. In addition, in the below-described post-welding additional heat treatment, an effect of improving the strength of a welded part cannot be obtained sufficiently.

As an indicator for determining whether the above-described artificial aging treatment has been appropriately completed, the rate of change in the electrical conductivity of the extruded profile before and after the artificial aging treatment is defined. That is, when the electrical conductivity before the artificial aging treatment is defined as X and the electrical conductivity after the artificial aging treatment is defined as Y, the present disclosure is achieved when an equation 0.120≤(Y/X−1)≤0.250 is satisfied. When (Y/X−1)<0.120, since the extruded profile is underaged, the stress corrosion cracking resistance is reduced. When 0.250<(Y/X−1), the strength of the extruded profile is reduced, and an effect of improving the strength of a welded part by a post-welding additional heat treatment cannot be obtained sufficiently.

To continuously perform the first artificial aging treatment and the second artificial aging treatment means to perform the second artificial aging treatment while maintaining the treatment temperature after the first artificial aging treatment. In other words, after the first artificial aging treatment, the process can proceed to the second artificial aging treatment without opening a furnace, and the time of the whole heat treatment can thereby be abbreviated.

It is not necessarily important to continuously perform the first artificial aging treatment and the second artificial aging treatment. For example, after the completion of the first artificial aging treatment, the second artificial aging treatment may be performed once the extruded profile is cooled to a desired temperature or lower, for example, room temperature. In these artificial aging treatments, not only between the first and the second artificial aging treatments but also between the respective artificial aging treatments, the extruded profile is treated at a desired temperature as appropriate even when the extruded profile has been once cooled to the desired temperature or lower, whereby the present disclosure can be achieved.

The extruded profile obtained in the above-described manner is welded with other aluminum alloy material, namely a welding member, by a method such as tungsten inert gas (TIG) welding or metal inert gas (MIG) welding, whereby a welded structure can be obtained (welding step).

On the welded structure obtained after the above-described welding, a heat treatment is performed at a performed at a temperature of 165 to 195° C. for 10 to 60 minutes as the heat treatment step. By this heat treatment step, the welded structural member of the present disclosure is produced. As this step, for example, the coating-baking step can be utilized as well.

When a heat-treated type aluminum alloy material such as a 7000-series aluminum alloy material is welded, due to the thermal effect during the welding, a solid solution region where precipitated η′ phase is dissolved into the matrix is generated in the vicinity of a welded part. In this solid solution region, the strength, the corrosion resistance and the stress corrosion cracking resistance are reduced; however, by performing the above-described heat treatment, these properties can be improved through reprecipitation of η′ phase.

One indicator for judging whether the strength, the corrosion resistance and the stress corrosion cracking resistance have been improved is the difference in the electrical conductivity of an unaffected mother portion and a solid solution region. In the solid solution region, the electrical conductivity is lower by at least 5% IACS than in the unaffected mother portion. By subjecting the welded structure obtained after welding to a heat treatment at a temperature of 165 to 195° C. for 10 to 60 minutes, the difference in electrical conductivity between the unaffected part and the solid solution region is controlled to be 5% by mass or less. When the heat treatment temperature is lower than 165° C. or the heat treatment time is shorter than 10 minutes, there may be a case where the difference in electrical conductivity is not 5% IACS or less and the above-described properties are not sufficiently improved. Meanwhile, when the heat treatment temperature is higher than 195° C. or the heat treatment time is longer than 60 minutes, progress of softening leads to deterioration of the mechanical properties. It is noted here that, in the following descriptions, a solid solution region generated by the thermal effect during welding is also referred to as “weld heat-affected zone”. In Examples, the electrical conductivity of an unaffected mother portion and that of a solid solution region are compared.

### EXAMPLES

Examples of the present disclosure are described below in comparison with Comparative Examples to demonstrate the effects of the present disclosure. The below-described Examples merely represent one embodiment of the present disclosure, and the present disclosure is not limited thereto by any means.

### Example 1

Example relating to the above-described welded structural member will now be described referring to Tables 1 to 3.

In this Example, for 7000-series aluminum alloy materials in which chemical compositions were changed within the above-described alloy composition ranges, extruded profiles were produced under the same conditions. For the thus obtained extruded profiles, the electrical conductivity before and after an artificial aging treatment and the mother portion strength were measured. Further, for samples obtained by welding the surfaces of the above-described mother portion samples and then performing a heat treatment under the same conditions, the electrical conductivity of a weld heat-affected zone and the strength were measured, and a stress corrosion cracking (SCC) test was conducted.

Sample production conditions, a strength measurement method, an electrical conductivity measurement method, and an SCC test method are described below.

<Sample Production Conditions>

### Method of Producing Extruded Profile

With the chemical composition shown in Table 1, a billet of 6 inches (152.4 mm) in diameter was produced by semi-continuous casting. In Table 1, “remainder” includes unavoidable impurities. Further, Mn and Cr are included in the unavoidable impurities when these elements were contained in a given sample No. in an amount of less than 0.01% by mass. Subsequently, after a homogenization treatment in which the billet was maintained at a temperature of 470° C. for 6 hours, the billet was heated again to 480° C. and hot-extruded to obtain an extruded profile of 3 mm in thickness. After this hot extrusion, the thus obtained extruded profile was press-quenched by air cooling. This extruded profile was maintained at a temperature of 100° C. for 3 hours to perform a first artificial aging treatment, and the resulting sample was heated to 150° C. and maintained for 8 hours as is without being taken out of a furnace to perform a second artificial aging treatment.

TABLE 1

| | Alloy composition (% by mass) | | | | | | | |
|---|---|---|---|---|---|---|---|---|
| Sample No. | Zn | Mg | Cu | Zr | Mn | Cr | Ti | Al |
| No. 1 | 6.6 | 1.1 | 0.15 | 0.15 | — | — | 0.01 | Remainder |
| No. 2 | 7.4 | 1.1 | 0.15 | 0.13 | — | — | 0.01 | Remainder |
| No. 3 | 8.2 | 1.1 | 0.15 | 0.14 | — | — | 0.01 | Remainder |
| No. 4 | 6.7 | 1.6 | 0.15 | 0.13 | — | — | 0.01 | Remainder |
| No. 5 | 6.8 | 2.1 | 0.15 | 0.14 | — | — | 0.01 | Remainder |
| No. 6 | 7.5 | 1.6 | 0.15 | 0.14 | — | — | 0.01 | Remainder |
| No. 7 | 8.2 | 2.0 | 0.15 | 0.15 | — | — | 0.01 | Remainder |
| No. 8 | 6.9 | 1.3 | 0.02 | 0.12 | — | — | 0.01 | Remainder |
| No. 9 | 7.0 | 1.3 | 0.38 | 0.14 | — | — | 0.01 | Remainder |
| No. 10 | 7.1 | 1.3 | 0.15 | 0.11 | — | — | 0.01 | Remainder |
| No. 11 | 7.1 | 1.3 | 0.15 | 0.20 | — | — | 0.01 | Remainder |
| No. 12 | 7.0 | 1.3 | 0.15 | 0.12 | 0.30 | — | 0.01 | Remainder |
| No. 13 | 7.1 | 1.3 | 0.15 | 0.13 | — | 0.16 | 0.01 | Remainder |
| No. 14 | 7.1 | 1.3 | 0.16 | 0.14 | 0.16 | 0.16 | 0.01 | Remainder |
| No. 15 | 6.0 | 1.4 | 0.15 | 0.11 | — | — | 0.01 | Remainder |
| No. 16 | 9.1 | 1.3 | 0.15 | 0.15 | — | — | 0.01 | Remainder |
| No. 17 | 6.8 | 0.7 | 0.15 | 0.13 | — | — | 0.01 | Remainder |
| No. 18 | 7.0 | 2.5 | 0.15 | 0.15 | — | — | 0.01 | Remainder |
| No. 19 | 7.0 | 1.4 | 0.59 | 0.13 | — | — | 0.01 | Remainder |
| No. 20 | 7.0 | 1.4 | 0.15 | 0.01 | — | — | 0.01 | Remainder |
| No. 21 | 6.9 | 1.3 | 0.17 | 0.28 | — | — | 0.01 | Remainder |
| No. 22 | 7.1 | 1.3 | 0.15 | 0.13 | 0.43 | — | 0.01 | Remainder |
| No. 23 | 7.2 | 1.3 | 0.15 | 0.12 | — | 0.32 | 0.01 | Remainder |

Welding Method

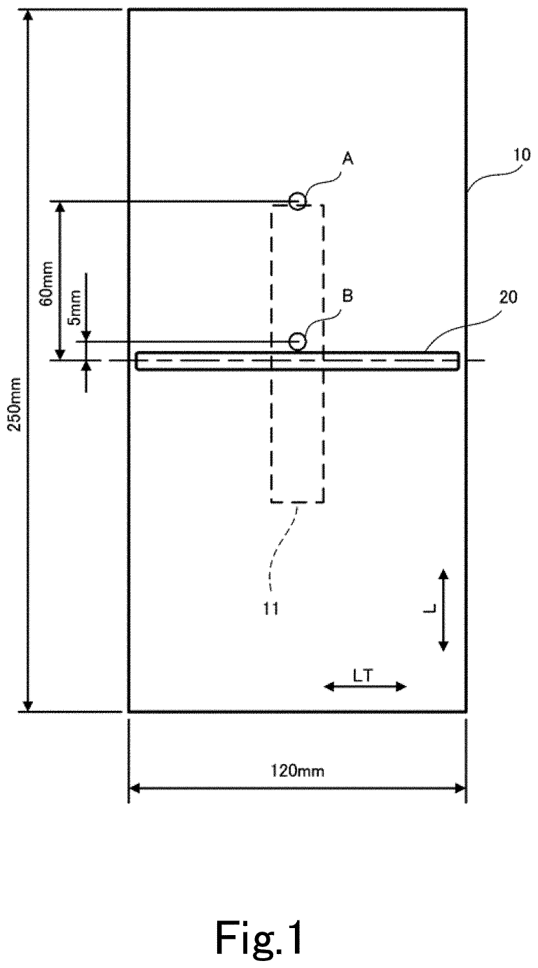

On the surface of an extruded profile 10 illustrated in FIG. 1, build-up welding was performed under the conditions shown in Table 2 to form a weld bead 20. The weld bead 20 was formed along an LT direction (direction perpendicular to the extrusion direction of the extruded profile) in the center of an L direction (extrusion direction) of the extruded profile 10 that had been cut. With regard to an SCC test piece 11 which will be described below, only the position thereof is indicated by a dotted line since the SCC test piece 11 had not yet been prepared from the extruded profile 10 at the time of the build-up welding.

TABLE 2

| | |
|---|---|
| Welding method | MIG welding |

| Filler metal | Alloy species | 5356 | |
|---|---|---|---|
| | Diameter | 1.2 | mm |
| Welding voltage | | 19 | V |
| Welding current | | 110 | A |
| Welding speed | | 800 | mm/min |
| Shielding gas | Gas species | Argon gas | |
| | Flow rate | 20 | L/min |

Heat Treatment Method

After the build-up welding, the extruded profile was subjected to a heat treatment at 170° C. for 20 minutes.

<Strength Measurement Method>

### Mother Portion Strength

From the extruded profile sample subjected to the artificial aging treatments and the heat treatment, a test piece was collected by a method according to JIS Z2241 (ISO6892-1). This test piece was formed into the JIS No. 13B shape, and the yield strength YS (MPa) of the mother portion was subsequently measured. As a result of the measurement, a test piece having a yield strength YS of 350 MPa or higher was judged to be acceptable.

Post-Welding Strength

From the extruded profile sample subjected to the build-up welding and the heat treatment, a test piece was collected referring to the method prescribed in JIS Z3121 (ISO4136). This test piece was formed into the HS No. 1A shape, and the yield strength YS (MPa) of the mother portion was subsequently measured. As a result of the measurement, a test piece having a yield strength YS of 285 MPa or higher was judged to be acceptable.

<Metallographic Structure Observation Method>

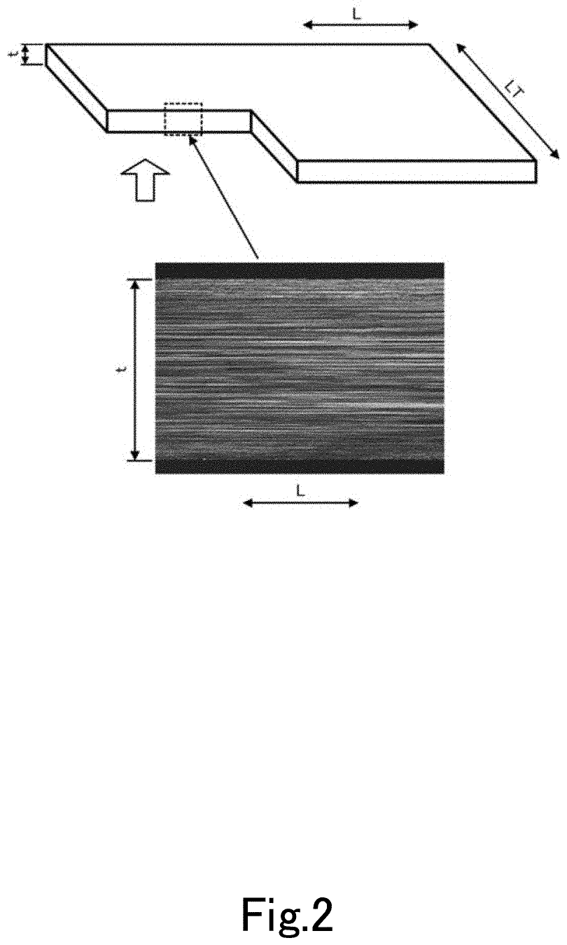

For each sample, at a cross-section parallel to both the L direction, which is a processing direction (extrusion direction in this case), and the thickness t direction as illustrated in FIG. 2, the structure of a portion in the vicinity of the center in the LT direction, which is the width direction, was observed. As illustrated in FIG. 2, an extruded material was cut out as a sample, mechanically polished and then electrolytically polished, after which a micrograph of a cross-section (for example, the photograph provided in the bottom of FIG. 2) was obtained under a polarization microscope at ×25 magnification. On the thus obtained micrograph, it was verified whether or not the metallographic structure was a fibrous structure extending in the processing direction. As a result of the observation, a metallographic structure having a fibrous structure ratio of 70% or higher was judged to be a fibrous structure.

<Electrical Conductivity Measurement Method>

Using an eddy current conductivity meter “SIGMATEST” manufactured by Foerster Japan Ltd., the electrical conductivity of the extruded profile before and after the artificial aging treatments as well as the electrical conductivity of an unaffected part and a heat-affected zone of the extruded profile 10 after the build-up welding and the heat treatment were measured. With regard to the extruded profile after the build-up welding and the heat treatment, as illustrated in FIG. 1, the measurement was performed at two positions A (unaffected mother portion) and B (solid solution region generated by welding) that were located at 60 mm and 5 mm away from the welding line of the weld bead 20, respectively. The measurement of the electrical conductivity was performed at room temperature and a frequency of 60 kHz.

<SCC Test Method>

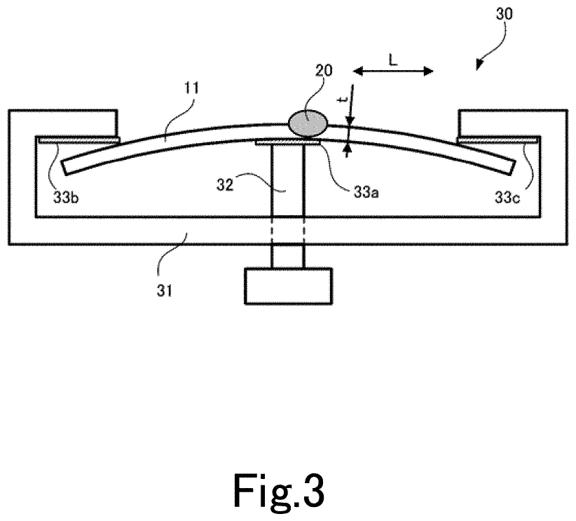

From the extruded profile 10 welded in the LT direction, an SCC test piece 11 was prepared as a three-point bending sample prescribed in JIS H8711 such that a maximum stress would be applied at a position on the boundary between the weld bead 20 and the mother portion surface. This SCC test piece 11 in the form of a flat plate was integrated into an SCC test jig 30 illustrated in FIG. 3.

The SCC test jig 30 includes a frame 31, a pressing part 32, and insulators 33a to 33c. The frame 31 is substantially C-shaped when viewed from the direction of the drawing. The insulators 33b and 33c are attached to the frame 31 at two spots. The pressing part 32 is screwed into the frame 31 and is movable in the vertical direction of the drawing. The insulator 33a is attached to the upper end of the pressing part 32.

FIG. 3 illustrates a state in which, after the integration of the SCC test piece 11 into the SCC test jig 30, the pressing part 32 has been moved in the upward direction of the drawing. As a result, the SCC test piece 11 is bent at three points where it is in contact with the insulators 33a to 33c.

A stress of 70% of the welding material yield strength was applied to the SCC test piece 11 in the L direction by three-point bending as illustrated in FIG. 3. In a room maintained at a room temperature of 25±3° C. and a humidity of 40 to 75%, the SCC test piece 11 with the stress being applied thereto was subjected to a 672-hour alternate immersion test in which 10-minute immersion in a 3.5%-by-mass aqueous NaCl solution and 50-minute drying in the room were repeated. Here, a test piece with no crack generation after the 672-hour test was judged to be acceptable. Meanwhile, from the standpoint of the corrosion resistance, a test piece having a maximum corrosion depth of 400 μm or greater was judged to be unacceptable even without crack generation.

The evaluation results of each test are shown in Table 3. In the SCC test results shown in Table 3, “◯” means acceptable and “x” means unacceptable.

TABLE 3

| | | Extruded profile | | | | | | | | | |
|---|---|---|---|---|---|---|---|---|---|---|---|
| | | Electrical conductivity | | | | | | | | | |
| | | (% IACS) | | | | | | | | | |
| | | Before | After | | | Welding material | | | | | |
| | | artificial | artificial | | | Electrical conductivity | | | | | |
| | Metallographic | aging | aging | | | (% IACS) | | | | | |
| | structure | treatment | treatment | | Ys | | | Position A − | YS | SCC test | |
| Sample No. | observation | [X] | [Y] | Y/X − 1 | (MPa) | Position A | Position B | Position B | (MPa) | results | Evaluation |
| No. 1 | Fibrous | 37.73 | 43.93 | 0.164 | 393 | 43.9 | 41.0 | 2.9 | 290 | ∘ | ∘ |
| No. 2 | Fibrous | 37.43 | 43.24 | 0.155 | 399 | 43.1 | 40.4 | 2.7 | 317 | ∘ | ∘ |
| No. 3 | Fibrous | 37.28 | 43.17 | 0.158 | 408 | 43.1 | 40.4 | 2.7 | 326 | ∘ | ∘ |
| No. 4 | Fibrous | 36.26 | 42.01 | 0.159 | 430 | 42.4 | 39.3 | 3.1 | 320 | ∘ | ∘ |
| No. 5 | Fibrous | 34.73 | 40.47 | 0.165 | 467 | 40.6 | 37.2 | 3.4 | 336 | ∘ | ∘ |
| No. 6 | Fibrous | 36.27 | 42.33 | 0.167 | 444 | 42.4 | 39.3 | 3.1 | 342 | ∘ | ∘ |
| No. 7 | Fibrous | 34.95 | 40.87 | 0.169 | 463 | 41.2 | 37.2 | 4.0 | 346 | ∘ | ∘ |
| No. 8 | Fibrous | 37.13 | 43.39 | 0.169 | 416 | 43.7 | 40.1 | 3.6 | 320 | ∘ | ∘ |
| No. 9 | Fibrous | 36.17 | 42.43 | 0.173 | 422 | 42.7 | 39.3 | 3.4 | 304 | ∘ | ∘ |
| No. 10 | Fibrous | 36.89 | 42.84 | 0.161 | 430 | 42.7 | 40.3 | 2.4 | 323 | ∘ | ∘ |
| No. 11 | Fibrous | 37.26 | 43.48 | 0.167 | 420 | 43.2 | 40.5 | 2.7 | 324 | ∘ | ∘ |
| No. 12 | Fibrous | 33.77 | 39.00 | 0.155 | 425 | 37.9 | 35.1 | 2.8 | 311 | ∘ | ∘ |
| No. 13 | Fibrous | 32.47 | 37.34 | 0.150 | 411 | 37.4 | 35.1 | 2.3 | 300 | ∘ | ∘ |
| No. 14 | Fibrous | 31.51 | 35.73 | 0.134 | 416 | 35.5 | 33.5 | 2.0 | 304 | ∘ | ∘ |
| No. 15 | Fibrous | 37.24 | 43.42 | 0.166 | 402 | 43.5 | 40.3 | 3.2 | 280 | ∘ | x |
| No. 16 | Fibrous | 36.99 | 42.72 | 0.155 | 424 | 42.8 | 38.4 | 4.4 | 329 | x | x |
| | | | | | | | | | | (Cracking) | |
| No. 17 | Fibrous | 39.54 | 44.47 | 0.125 | 331 | 44.4 | 41.9 | 2.5 | 224 | ∘ | x |
| No. 18 | Production was suspended due to a low extrusion rate. | | | | | | | | | | x |
| No. 19 | Fibrous | 35.74 | 42.46 | 0.188 | 423 | 43.0 | 39.0 | 4.0 | 300 | x | x |
| | | | | | | | | | | (Corrosion) | |
| No. 20 | Recrystallized | 36.41 | 42.71 | 0.173 | 399 | 42.3 | 40.5 | 1.8 | 305 | x | x |
| | | | | | | | | | | (Cracking) | |
| No. 21 | Fibrous | 36.12 | 43.58 | 0.207 | 420 | 43.4 | 40.5 | 2.9 | 323 | ∘ | x |
| | (with coarse | | | | | | | | | | |
| | compound) | | | | | | | | | | |
| No. 22 | Production was suspended due to a low extrusion rate. | | | | | | | | | | x |
| No. 23 | Fibrous | 32.67 | 37.62 | 0.151 | 357 | 36.5 | 33.6 | 2.9 | 278 | ∘ | x |

The samples No. 1 to No. 14 were acceptable in all of the items, exhibiting excellent properties.

The sample No. 15 was judged to be unacceptable since the yield strength YS of the welding material was lower than 285 MPa due to an excessively low Zn content.

The sample No. 16 was judged to be unacceptable since cracking occurred in the SCC test due to an excessively high Zn content.

The sample No. 17 was judged to be unacceptable since, due to an excessively low Mg content, the yield strength YS of the mother portion was lower than 350 MPa and the yield strength YS of the welding material was lower than 285 MPa.

The sample No. 18 had an excessively high Mg content, and hot extrusion thereof was thus impossible using a practical equipment.

The sample No. 19 was judged to be unacceptable since corrosion of 400 μm or greater in depth occurred in the SCC test due to an excessively high Cu content.

The sample No. 20 was judged to be unacceptable since, due to an excessively low Zr content, the metallographic structure was a recrystallized structure, and cracking occurred in the SCC test.

The sample No. 21 was judged to be unacceptable since, due to an excessively high Zr content, a coarse compound was observed in the metallographic structure.

The sample No. 22 had an excessively high Mn content, and hot extrusion thereof was thus impossible using a practical equipment.

The sample No. 23 had an excessively high Cr content, and hot extrusion thereof was thus impossible using a practical equipment.

### Example 2

Example relating to the above-described method of producing a welded structural member will now be described referring to Tables 4 to 6.

In this Example, for 7000-series aluminum alloy materials having the above-described respective alloy composition ranges, extruded profiles were produced under the same conditions. Samples were prepared by subjecting the thus obtained extruded profiles to artificial aging treatments under different conditions, and the mother portion strength was measured. Further, for samples obtained by welding the surfaces of the above-described mother portion samples and then performing a heat treatment under different conditions, the electrical conductivity of a weld heat-affected zone was measured and an SCC test was conducted. Sample production conditions, a strength measurement method, an electrical conductivity measurement method, and an SCC test method are described below.

<Sample Production Conditions>

### Method of Producing Extruded Profile

With the composition shown in Table 4, a billet of 6 inches (152.4 mm) in diameter was produced by semi-continuous casting. In Table 4, “remainder” includes unavoidable impurities. Further, in all sample Nos., Mn and Cr were contained in an amount of 0.01% by mass and thus included in the unavoidable impurities. Subsequently, after a homogenization treatment in which the billet was maintained at a temperature of 470° C. for 6 hours, the billet was heated again to 480° C. and hot-extruded to obtain an extruded profile of 3 mm in thickness. After this hot extrusion, the thus obtained extruded profile was press-quenched by air cooling. This extruded profile was subjected to artificial aging treatments under the respective conditions shown in Table 5 to prepare samples No. a to No. i.

TABLE 4

| | Alloy composition (% by mass) | | | | | | | |
|---|---|---|---|---|---|---|---|---|
| Sample No. | Zn | Mg | Cu | Zr | Mn | Cr | Ti | Al |
| No. a − | 7.0 | 1.4 | 0.15 | 0.12 | — | — | 0.01 | Remainder |
| No. i | | | | | | | | |

TABLE 5

| | First artificial aging treatment | | Second artificial aging treatment | | Post-welding heat treatment | |
|---|---|---|---|---|---|---|
| Sample No. | Temperature (° C.) | Time (h) | Temperature (° C.) | Time (h) | Temperature(° C.) | Time (min) |
| No. a | 90 | 1 | 150 | 8 | 170 | 20 |
| No. b | 110 | 5 | 150 | 8 | 170 | 20 |
| No. c | 100 | 3 | 160 | 12 | 170 | 20 |
| No. d | 100 | 3 | 150 | 8 | 170 | 10 |
| No. e | 100 | 3 | 150 | 8 | 190 | 60 |
| No. f | 100 | 3 | 140 | 4 | 170 | 20 |
| No. g | 100 | 3 | 175 | 8 | 170 | 20 |
| No. h | 100 | 3 | 150 | 8 | as welded | |
| No. i | 100 | 3 | 150 | 8 | 200 | 60 |

Welding Method

In the same manner as in Example 1, build-up welding was performed on the surface of the extruded profile 10 illustrated in FIG. 1 under the conditions shown in Table 2.

Heat Treatment Method

The samples No. a to No. i after the build-up welding were subjected to a heat treatment under the respective conditions shown in Table 5.

<Strength Measurement Method>

### Mother Portion Strength

From each extruded profile sample subjected to the artificial aging treatments and the heat treatment, a test piece was collected by a method according to JIS Z2241 (ISO6892-1). This test piece was formed into the JIS No. 13B shape, and the yield strength YS (MPa) of the mother portion was subsequently measured. As a result of the measurement, a test piece having a yield strength YS of 350 MPa or higher was judged to be acceptable.

Post-Welding Strength

From each extruded profile sample subjected to the build-up welding and the heat treatment, a test piece was collected referring to the method prescribed in JIS Z3121 (ISO4136). This test piece was formed into the JIS No. 1A shape, and the yield strength YS (MPa) of the mother portion was subsequently measured. As a result of the measurement, a test piece having a yield strength YS of 285 MPa or higher was judged to be acceptable.

<Electrical Conductivity Measurement Method>

Using an eddy current conductivity meter “SIGMATEST” manufactured by Foerster Japan Ltd., the electrical conductivity of the extruded profile before and after the artificial aging treatments as well as the electrical conductivity of an unaffected part and a heat-affected zone of the extruded profile 10 after the build-up welding and the heat treatment were measured. With regard to the extruded profile after the build-up welding and the heat treatment, as illustrated in FIG. 1, the measurement was performed at two positions A (unaffected mother portion) and B (solid solution region generated by welding) that were located at 60 mm and 5 mm away from the welding line of the weld bead 20, respectively. The measurement of the electrical conductivity was performed at room temperature and a frequency of 60 kHz.

<SCC Test Method>

From the extruded profile 10 welded in the LT direction, an SCC test piece 11 was prepared as a three-point bending sample prescribed in JIS H8711 such that the solid solution region generated during the welding was positioned in the center. A stress of 70% of the welding material yield strength was applied to the SCC test piece 11 in the L direction by three-point bending as illustrated in FIG. 3 in the same manner as in Example 1. In a room maintained at a room temperature of 25±3° C. and a humidity of 40 to 75%, the SCC test piece 11 with the stress being applied thereto was subjected to a 672-hour alternate immersion test in which 10-minute immersion in a 3.5%-by-mass aqueous NaCl solution and 50-minute drying in the room were repeated. Here, a test piece with no crack generation after the 672-hour test as well as a test piece having a maximum corrosion depth of 400 μm or less were judged to be acceptable.

The evaluation results of each test are shown in Table 6. In the SCC test results shown in Table 6, “◯” means acceptable and “x” means unacceptable.

TABLE 6

| | Extruded profile | | | | | | | | | |
|---|---|---|---|---|---|---|---|---|---|---|
| | Electrical conductivity | | | | Welding material | | | | | |
| | (% IACS) | | | | Electrical conductivity | | | | | |
| | Before artificial | After artificial | | | (% IACS) | | | | | |
| | aging treatment | aging treatment | | YS | | | Position A − | YS | SCC test | |
| Sample No. | [X] | [Y] | Y/X − 1 | (MPa) | Position A | Position B | Position 8 | (MPa) | results | Evaluation |
| No. a | 36.97 | 43.02 | 0.164 | 418 | 43.4 | 41.0 | 2.4 | 318 | ∘ | ∘ |
| No. b | 36.85 | 43.03 | 0.168 | 420 | 43.5 | 40.9 | 2.6 | 322 | ∘ | ∘ |
| No. c | 37.05 | 45.04 | 0.216 | 392 | 45.4 | 40.5 | 4.8 | 304 | ∘ | ∘ |
| No. d | 37.01 | 42.94 | 0.160 | 431 | 42.9 | 39.6 | 3.3 | 292 | ∘ | ∘ |
| No. e | 36.98 | 42.96 | 0.162 | 373 | 45.1 | 43.9 | 1.2 | 345 | ∘ | ∘ |
| No. f | 36.91 | 41.09 | 0.113 | 418 | 41.4 | 40.7 | 0.7 | 334 | x | x |
| | | | | | | | | | (Cracking) | |
| No. g | 37.02 | 47.60 | 0.286 | 334 | 47.3 | 41.5 | 5.8 | 281 | ∘ | x |
| No. h | 36.89 | 42.97 | 0.165 | 424 | 43.0 | 36.1 | 6.9 | 278 | x | x |
| | | | | | | | | | (Corrosion) | |
| No. i | 36.95 | 43.02 | 0.164 | 325 | 45.6 | 43.7 | 1.9 | 316 | ∘ | x |

The samples No. a to No. e were acceptable in all of the items, exhibiting excellent properties.

The sample No. f was judged to be unacceptable since cracking occurred in the SCC test due to a low second artificial aging temperature.

The sample No. g was judged to be unacceptable since sufficient mechanical properties were not obtained due to a high second artificial aging temperature.

The sample No. h was judged to be unacceptable since it remained as welded (in a welded state) and corrosion of 400 μm or greater in depth occurred in the SCC test.

The sample No. i was judged to be unacceptable since sufficient mechanical properties were not obtained due to a high post-welding heat treatment temperature.

The foregoing describes some example embodiments for explanatory purposes. Although the foregoing discussion has presented specific embodiments, persons skilled in the art will recognize that changes may be made in fount and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2019-186120, filed on Oct. 9, 2019, the entire disclosure of which is incorporated by reference herein.

### INDUSTRIAL APPLICABILITY

The welded structural member according to the present disclosure and the method of producing the same according to the present disclosure can be preferably applied to, for example, transportation equipment.

### REFERENCE SIGNS LIST

10 Extruded profile
11 SCC test piece
20 Weld bead
30 SCC test jig
31 Frame
32 Pressing part
33a, 33b, 33c Insulator
A, B Position

1. A welded structural member with excellent stress corrosion cracking resistance, the welded structural member comprising:
a 7000-series aluminum alloy material that has a chemical composition comprising 6.6% by mass to 8.5% by mass of Zn, 1.0% by mass to 2.1% by mass of Mg, 0.10% by mass to 0.20% by mass of Zr, 0.001% by mass to 0.05% by mass of Ti, 0.02% by mass to 0.50% by mass of Cu, 0.40% by mass or less of Mn, and 0.20% by mass or less of Cr, with a remainder comprising Al and unavoidable impurities, and includes a metallographic structure that is a fibrous structure; and
other aluminum alloy material welded with the 7000-series aluminum alloy material, wherein
in the 7000-series aluminum alloy material,
a difference in the electrical conductivity of the 7000-series aluminum alloy material between a mother portion other than a weld heat-affected zone and the weld heat-affected zone is 1.2% IACS to 5% IACS, and
a yield strength YS of the mother portion if 350 MPa or higher.

2. The welded structural member according to claim 1, wherein the 7000-series aluminum alloy material comprises 0.16% by mass to 0.40% by mass of Mn.

3. The welded structural member according to claim 1, wherein the 7000-series aluminum alloy material comprises 0.16% by mass to 0.20% by mass of Cr.

4. The welded structural member according to claim 1, wherein the 7000-series aluminum alloy material comprises 6.6% by mass to 7.6% by mass of Zn, and 1.0% by mass to 1.6% by mass of Mg.

5. A production method of producing a welded structural member with excellent stress corrosion cracking resistance, the method comprising:
the first artificial aging treatment step of maintaining a 7000-series aluminum alloy material at a temperature of 90 to 110° C. for 1 to 5 hours, which 7000-series aluminum alloy material has a chemical composition comprising 6.6% by mass to 8.5% by mass of Zn, 1.0% by mass to 2.1% by mass of Mg, 0.10% by mass to 0.20% by mass of Zr, 0.001% by mass to 0.05% by mass of Ti, 0.02% by mass to 0.50% by mass of Cu, 0.40% by mass or less of Mn, and 0.20% by mass or less of Cr,
with a remainder comprising Al and unavoidable impurities, and includes a metallographic structure that is a fibrous structure;
the second artificial aging treatment step of maintaining the 7000-series aluminum alloy material subjected to the first artificial aging treatment step at a temperature of 145 to 160° C. for 4 to 12 hours;
the welding step of welding the 7000-series aluminum alloy material subjected to the second artificial aging treatment step with other aluminum alloy material to form a welded structure; and
the heat treatment step of heat-treating the welded structure at a temperature of 165 to 195° C. for 10 to 60 minutes.

6. The production method according to claim 5, wherein the 7000-series aluminum alloy material comprises 0.16% by mass to 0.40% by mass of Mn.

7. The production method according to claim 5, wherein the 7000-series aluminum alloy material comprises 0.16% by mass to 0.20% by mass of Cr.

8. The production method according to claim 5, wherein the 7000-series aluminum alloy material comprises 6.6% by mass to 7.6% by mass of Zn, and 1.0% by mass to 1.6% by mass of Mg.
